(19) United States
(12) Patent Application Publication
(10) Pub. No.: US 2026/0117804 A1
(43) Pub. Date: Apr. 30, 2026

(54) CLAMP, CONNECTION ASSEMBLY AND KIT FOR CONNECTION ASSEMBLY

(71) Applicant: SOUCY INTERNATIONAL INC., Drummondville (CA)

(72) Inventors: Gabriel BOISVERT, Beloeil (CA); Matthieu VANDEWYNCKELE, Drummondville (CA); Laurent LEMAY, Drummondville (CA); Dominique BOUDREAU, Roxton Falls (CA)

(21) Appl. No.: 19/369,675

(22) Filed: Oct. 27, 2025

Related U.S. Application Data
(60) Provisional application No. 63/713,145, filed on Oct. 29, 2024.

(51) Int. Cl. F16B 2/18

(52) U.S. Cl. CPC F16B 2/18

(57) ABSTRACT

A clamp, which is for coupling an accessory to a rail, includes a housing, first and second jaws, a biasing member, and an actuator. At least one of the first and second jaws is a pivoting jaw pivotable relative to the housing about a jaw axis between open and closed positions. The biasing member biases the pivoting jaw toward the open position. The actuator is pivotable relative to the housing about an actuator axis between actuated and non-actuated positions. In response to the actuator moving from the non-actuated position toward the actuated position, the actuator causing the pivoting jaw to move toward the closed position. The clamp has an unclamped configuration, and a clamped configuration in which the actuator is in the actuated position, the pivoting jaw is in the closed position, and the actuator prevents the pivoting jaw to move toward the open position.

### CROSS-REFERENCE TO RELATED APPLICATIONS

This application claims the benefit of U.S. Provisional Application No. 63/713,145, filed on Oct. 29, 2024. The contents of the aforementioned application is incorporated by reference in its entirety herein.

### TECHNICAL FIELD

The present technology relates to clamps for connecting accessories to connecting interfaces, connection assemblies and kits for connection assemblies.

### BACKGROUND

Clamps can be used to couple one or more accessories to connecting interfaces. In some instances, the connecting interfaces may be rails disposed on vehicles for coupling accessories to said vehicles.

Connecting conventional clamps to connecting interfaces and disconnecting conventional clamps to connecting interfaces can be time consuming and can require tools for installing and/or removing fasteners.

Additionally, some clamps can require apertures in the connecting surfaces in order for them to be connected to the connecting surfaces, such that the position of the clamps may not be selectively adjustable.

Therefore, there is a desire for a device that can mitigate at least some of the above-mentioned issues.

### SUMMARY

It is an object of the present technology to ameliorate at least some of the inconveniences present in the prior art.

According to one aspect of the present technology, there is provided a clamp for coupling an accessory to a rail. The clamp includes a housing, first and second jaws, a biasing member, and an actuator. The first jaw is disposed on a first side of the housing. The second jaw disposed on a second side of the housing, the second side being opposite to the first side. At least one of the first jaw and the second jaw is a pivoting jaw pivotable relative to the housing about a jaw axis between an open position and a closed position. The biasing member biases the pivoting jaw toward the open position. The actuator is connected to the housing, is pivotable relative to the housing about an actuator axis between an actuated position and a non-actuated position. In response to the actuator moving from the non-actuated position toward the actuated position, the actuator causes the pivoting jaw to move toward the closed position. The clamp has an unclamped configuration, and a clamped configuration. In the clamped configuration, the actuator is in the actuated position, the pivoting jaw is in the closed position, and the actuator prevents the pivoting jaw to move toward the open position.

In some embodiments, in the unclamped configuration, the actuator is in the non-actuated position, and the pivoting jaw is in the open position.

In some embodiments, in the unclamped configuration, the actuator prevents the pivoting jaw to move toward the closed position.

In some embodiments, the actuator includes a handle and a shaft rotationally fixed to the handle.

In some embodiments, the non-actuated position and the actuated position are angularly spaced from one another by about 90 degrees.

In some embodiments, the actuator axis extends from the first side of the housing to the second side of the housing, and is generally perpendicular to the jaw axis.

In some embodiments, the housing has a housing indicator, the actuator has an actuator indicator, and in response to the actuator being in one of the actuated position and the non-actuated position, the actuator indicator engages with the housing indicator.

In some embodiments, the actuator has an engaging portion, the pivoting jaw has an engaging surface, and with the clamp being in the clamped configuration, the engaging portion engages the engaging surface.

In some embodiments, the engaging portion is a cam.

In some embodiments, the cam has a flat surface configured to engage the engaging surface.

In some embodiments, one of the first jaw and the second jaw defines an aperture, and the actuator is received through the aperture.

In some embodiments, at least one of the actuator and the pivoting jaw has a retainer configured to retain the clamp in the clamped configuration.

In some embodiments, the retainer is a channel, the channel being defined in the pivoting jaw, and being configured to receive part of the actuator therein.

In some embodiments, the clamp further includes a lock for locking the actuator in the actuated position.

In some embodiments, the actuator defines a first locking aperture, the housing defines a second locking aperture, and the lock is a pin selectively received in the first locking aperture and the second locking aperture for locking a position of the actuator with respect to the housing.

In some embodiments, the housing is configured to connect to an accessory.

In some embodiments, the housing is integral with an accessory.

In some embodiments, the clamp further includes a top plate connected to the housing, the top plate being configured to connect to an accessory.

In some embodiments, the housing is at least partially complementary to the rail.

In some embodiments, at least one of the first jaw and the second jaw has a rubber portion.

In some embodiments, the pivoting jaw is a first pivoting jaw, an other one of the at least one of the first jaw and the second jaw is a second pivoting jaw, and the biasing member biases the first jaw toward the open position.

In some embodiments, the biasing member is a first biasing member, and the clamp further includes a second biasing member biasing the second pivoting jaw toward the open position.

According to another aspect of the present technology, there is provided a connection assembly including a rail, and the clamp according to the above aspect or according to the above aspect and one or more of the above embodiments, the clamp being selectively connected to the rail.

In some embodiments, the clamp is configured to be selectively connected to the rail in a plurality of positions along a length of the rail.

In some embodiments, the rail defines a first outer channel on a first rail side, and a second outer channel on a second rail side. With the clamp being clamped to the rail, the clamp is in the clamped configuration, the first jaw is partially received in the first outer channel, and the second jaw is partially received in the second outer channel.

In some embodiments, the first jaw and the second jaw partially surround the rail.

In some embodiments, the first jaw has a first hook, the second jaw has a second hook, the first outer channel is partially defined by a first upper wall, and the second outer channel is partially defined by a second upper wall. With the clamp being clamped to the rail, the first hook pushes on the first upper wall and the second hook pushes on the second upper wall.

In some embodiments, the rail defines a longitudinal direction, and the actuator axis extends generally perpendicular to the longitudinal direction.

According to another aspect of the present technology, there is provided a kit for coupling an accessory to a rail, the kit includes a clamp and a rail. The clamp includes a housing, first and second jaws, a biasing member and an actuator. The first jaw is disposed on a first side of the housing. The second jaw is disposed on a second side of the housing, the second side being opposite to the first side. At least one of the first jaw and the second jaw is a pivoting jaw pivotable relative to the housing about a jaw axis between an open position and a closed position. The biasing member biases the pivoting jaw toward the open position. The actuator is connected to the housing, and is pivotable relative to the housing about an actuator axis between an actuated position and a non-actuated position. In response to the actuator moving from the non-actuated position toward the actuated position, the actuator causing the pivoting jaw to move toward the closed position. The clamp has an unclamped configuration; and a clamped configuration in which the actuator is in the actuated position, the pivoting jaw is in the closed position, and the actuator prevents the pivoting jaw to move toward the open position.

Additional and/or alternative features, aspects, and advantages of implementations of the present technology will become apparent from the following description, and the accompanying drawings.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a top, front, left side of a clamp according to an embodiment of the present technology connected to a rail according to an other embodiment of the present technology;

FIG. 2 is a perspective view taken from a bottom, front, left side of the clamp of FIG. 1;

FIG. 3 is a perspective view taken from a top, front, right side of the clamp of FIG. 1, with a top plate thereof being omitted;

FIG. 4 is a perspective view taken from a top, front, left side of a housing of the clamp of FIG. 1;

FIG. 5 is a perspective view taken from a rear right side of a left jaw of the clamp of FIG. 1;

FIG. 6 is a perspective view taken from a rear, right side of the left jaw of FIG. 5, with a rubber portion connected thereto;

FIG. 7 is a perspective view taken from a top, rear, right side of an actuator of the clamp of FIG. 1;

FIG. 8A is a perspective view taken from a rear, top, left side of the clamp of FIG. 1 connected to the rail of FIG. 1, with the clamp being in an unclamped configuration;

FIG. 8B is a cross-sectional perspective view taken along a lateral plane of the clamp of FIG. 8A;

FIG. 8C is a cross-sectional elevation view of FIG. 8B;

FIG. 8D is a top plan view of the clamp of FIG. 8A, with part of the clamp being shown in transparency;

FIG. 9A is a perspective view taken from a rear, top, left side of the clamp of FIG. 1 connected to the rail of FIG. 1, with the clamp being in a clamped configuration;

FIG. 9B is a cross-sectional perspective view taken along a lateral plane of the clamp of FIG. 9A;

FIG. 9C is a cross-sectional elevation view of FIG. 9B;

FIG. 9D is a top plan view of the clamp of FIG. 9A, with part of the clamp being shown in transparency;

FIG. 10 is a perspective view taken from a rear, top, left side of a clamp according to an alternative embodiment of the present technology connected to the rail of FIG. 1; and

FIG. 11 is a perspective view taken from a top, front, left side of the rail of FIG. 1;

FIG. 12 is a front elevation view of the rail of FIG. 11, with an end cap of the rail being omitted;

FIG. 13A is front elevation view of the clamp of FIG. 1 being connected to the rail of FIG. 1 and to a light source; and

FIG. 13B is a front elevation view of the clamp of FIG. 1 being connected to the rail of FIG. 1 and to a holding structure.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

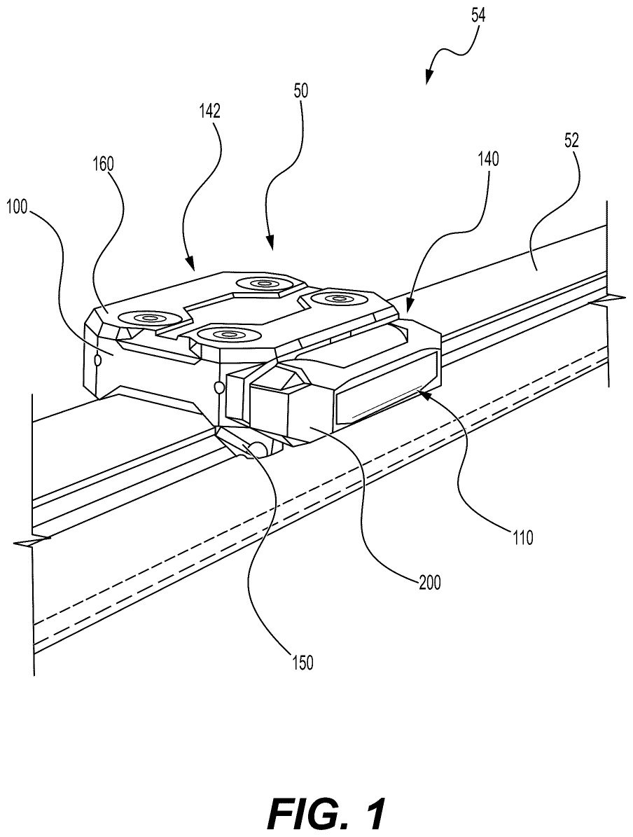

Referring to FIG. 1, a clamp 50 and a rail 52 according to embodiments of the present technology are shown connected to one another. The clamp 50 and the rail 52 may be provided as a connection assembly 54. In some embodiments, the connection assembly 54 may be provided as a kit. As will be described below, the clamp 50 is configured to be selectively connected to the rail 52 anywhere along a length thereof. In the accompanying Figures, the rail 52 is oriented to extend generally parallel to a horizontal plane. It is contemplated, however, that the orientation of the rail 52 may vary. For example, the rail 52 could be positioned to extend vertically or at an angle.

For purposes of the present description, terms related to spatial orientation such as vertically upward, vertically downwardly, laterally inward and laterally outward, are as they would normally be understood by a person facing a direction of a length of the rail 52 with a center of the rail 52 corresponding to a lateral and vertical center of the rail 52.

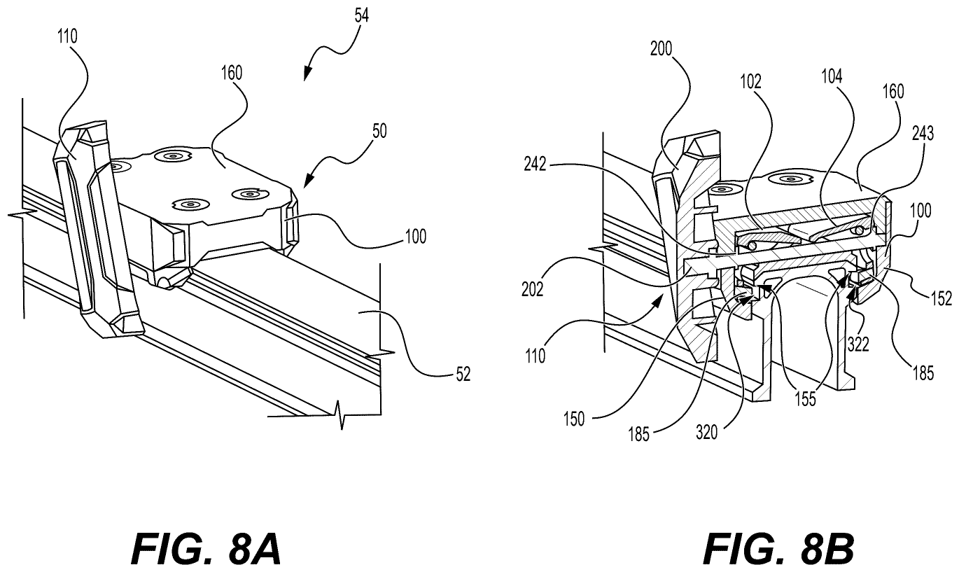

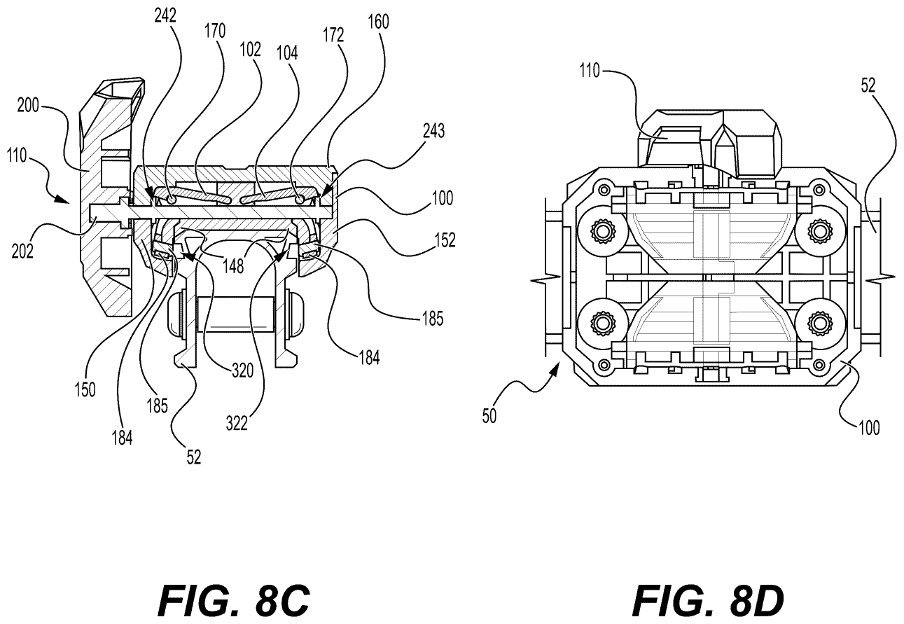

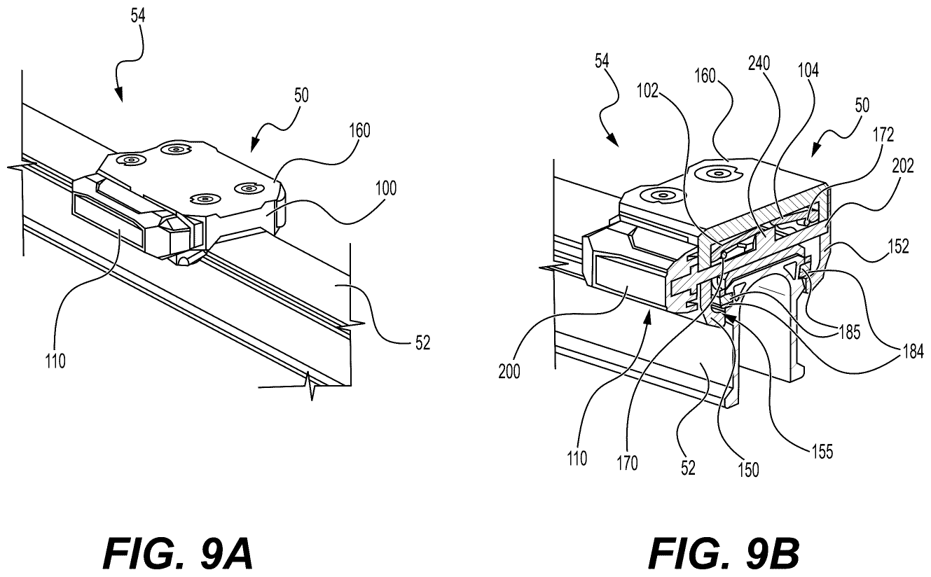

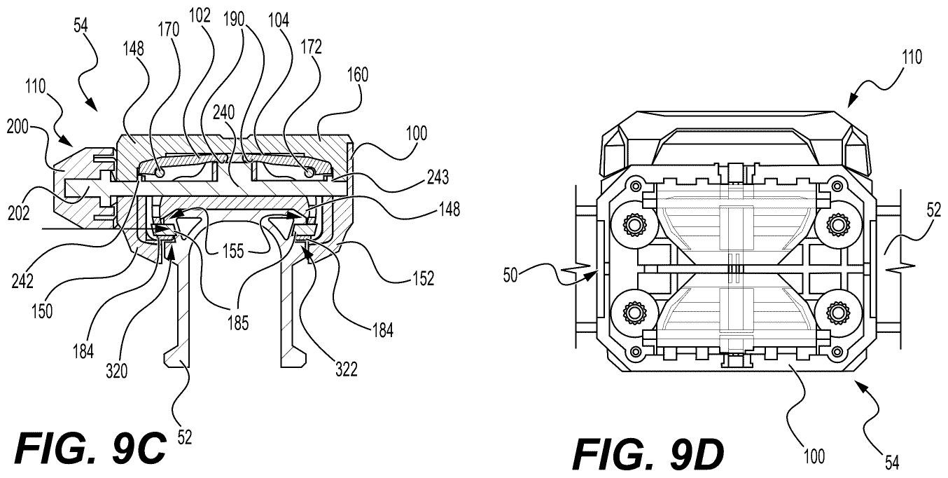

Referring to FIGS. 1 to 3, the clamp 50 includes a housing 100, jaws 102, 104, biasing members 106, 108 and an actuator 110. It is contemplated that the clamp 50 may have more or fewer components. As will be described below, the clamp 50 can selectively be moved between an unclamped configuration, in which the jaws 102, 104 are in their open positions (shown in FIGS. 8A to 8D), and a clamped configuration, in which the jaws 102, 104 are in their closed positions (shown in FIGS. 9A to 9D).

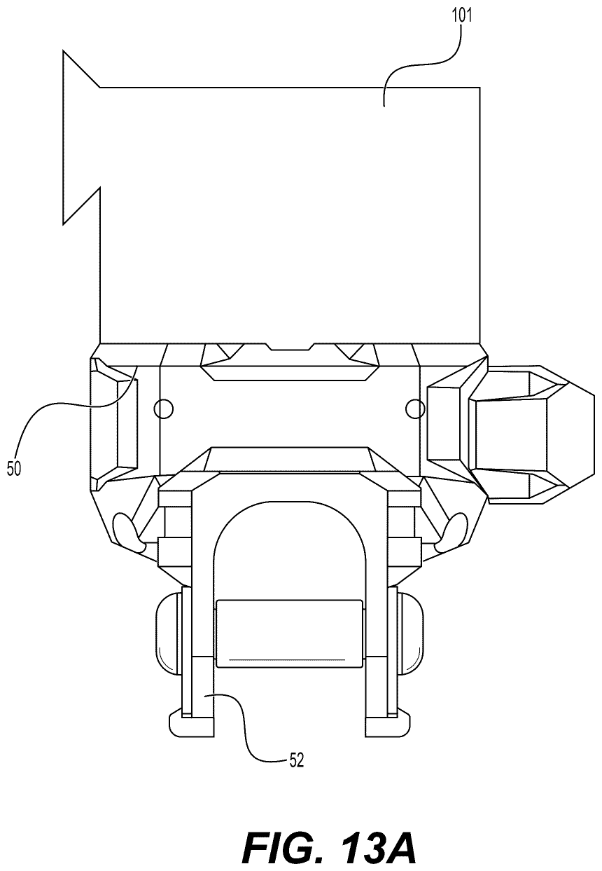

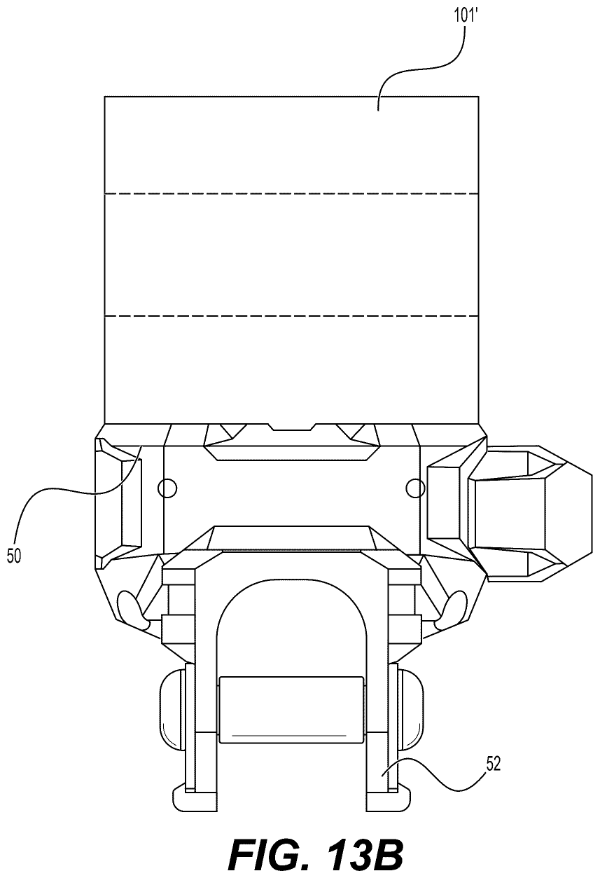

The housing 100 is configured to connect to an accessory 101. In the embodiment illustrated in FIG. 13A, the accessory 101 is a light source 101. In the alternative embodiment illustrated in FIG. 13B, the accessory 101′ is a holding structure 101′ for holding a device. It is contemplated that the accessories 101 and 101′ could vary without departing from the scope of the present technology. In some instances, the housing 100 may be selectively connected to the accessory 101 via, for example, fasteners. In other instances, the housing 100 may be permanently connected to the accessory 101, for example, the housing 100 may be integral with the accessory 101.

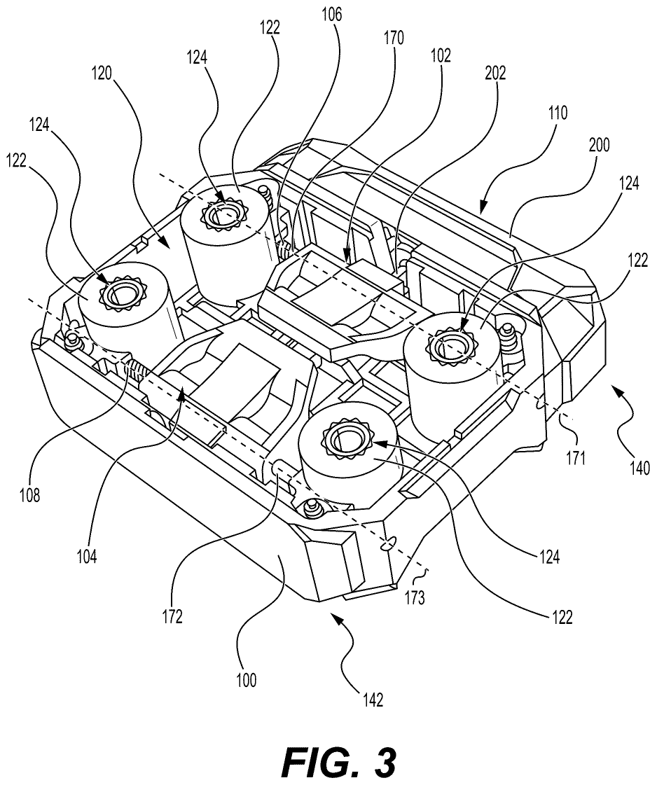

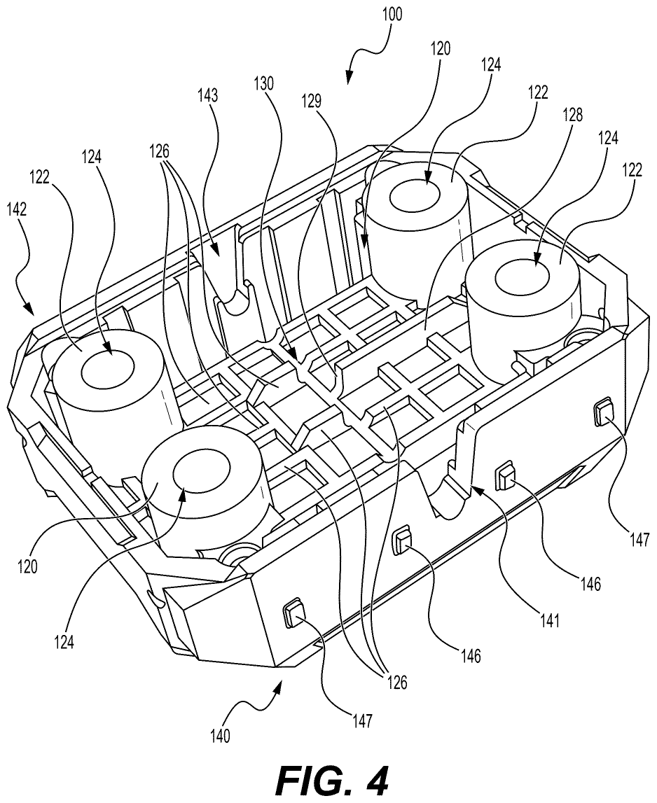

Referring to FIGS. 3 and 4, the housing 100 defines an upper recess 120 for receiving, inter alia, at least part of the jaws 102, 104, the biasing members 106, 108 and part of the actuator 110. Thus, it can be said that the housing 100 is partially hollow.

The housing 100 has four members 122 generally disposed at each corner of the upper recess 120. The four members 122 are cylindrical members, although it is understood that the shape thereof may vary. It is also contemplated that there could be more or fewer than four members 122. The members 122 are configured to connect to the accessory 101. To this end, each one of the four members 122 defines a threaded aperture 124 that is configured to receive a threaded fastener. Thus, the housing 100 may connect to the accessory 101 via at least some of the four members 122 and the corresponding threaded apertures 124.

With reference to FIG. 4, and still within the upper recess 120, the housing 100 has reinforcing ribs 126 for reinforcing the structural integrity of the housing 100. The size and shape of the reinforcing ribs 126 may vary from one rib to another. The housing 100 also has a guiding rib 128. The guiding rib 128 has an arcuate end 129. As will be described below, the arcuate end 129 is configured to engage with and guide movement of the actuator 110. The reinforcing ribs 126 and the guiding rib 128 define a channel 130 for receiving part of the actuator 110.

The housing 100 further defines, on a side 140 thereof, an aperture 141 and on a side 142 thereof, a recess 143. The aperture 141 and the recess 143 are configured to receive parts of the actuator 110 therein. On the outer surface of the side 140, the housing 100 has first housing indicators 146 and second housing indicators 147. The first and second housing indicators 146, 147 are protrusions, but it is contemplated that the first and second housing indicators 146, 147 could be other types of indicators such as recesses. As will be described below, the housing indicators 146, 147 are configured to engage with actuator indicators 212, 222, 223.

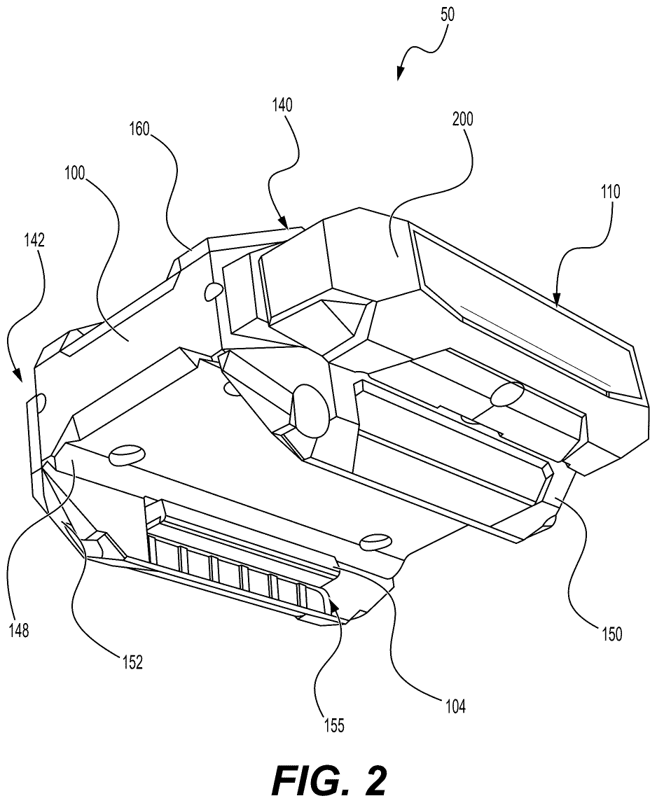

Best seen in FIGS. 2, 8C and 9C, a bottom surface of the housing 100 is complementary to a top portion of the rail 52 (described in greater detail below), which can enhance connection between the clamp 50 and the rail 52, while also facilitating movement of the clamp 50 relative to the rail 52. In the illustrated embodiment, the bottom of the housing 100 has angled surfaces 148 at each lateral side thereof.

Referring back to FIG. 2, the housing 100 also has a side member 150 disposed on the side 140 of the housing 100, and a side member 152 disposed on the side 142 of the housing 100. The side members 150, 152 extend vertically downward. The side members 150, 152 are spaced from one another, are sized and are shaped such that when the clamp 50 is placed and/or connected to the rail 52, the side members 150, 152 extend on either side of the rail 52. Thus, the side members 150, 152 can limit movement of the clamp 50 in a lateral direction and/or rotational movement relative to the rail 52, but do not limit movement of the clamp 50 vertically away from the rail 52.

The side members 150, 152 each define an aperture 155 (only the aperture 155 is shown in FIG. 2). The apertures 155 extend a length of the side members 150, 152, and are configured to receive part of the jaws 102, 104 therethrough.

A top plate 160 is connected to the housing 100. In some embodiments, the top plate 160 may be integral with the housing 100. In yet other embodiments, the top plate 160 may be integral with the accessory 101. In some embodiments, the top plate 101 may be configured to connect to the accessory 101.

Referring to FIGS. 3, 5 and 6, the jaws 102, 104 will now be described in greater detail. The jaw 102 is disposed proximate to the side 140 of the housing 100 and the jaw 104 is disposed proximate to the side 142 of the housing 100.

The jaw 102 is connected to the housing 100 via a shaft 170 that defines a jaw axis 171, and the jaw 104 is connected to the housing 100 via a shaft 172 that defines a jaw axis 173. The jaws 102, 104 can rotate with respect to their respective shafts 170, 172 and thus, can pivot with respect to their respective jaw axes 171, 173. Each one of the jaws 102, 104 can therefore be said to both be a pivotable jaw that can, as will be described below, pivot between an open position (FIGS. 8A to 8D) and a closed position (FIGS. 1, 2, and 9A to 9D). It is contemplated that in other embodiments, only one of the jaws 102, 104 could be a pivotable jaw. In one example, the jaw 102 could be fixed in place and the jaw 104 could be pivotable or vice versa. The jaw axes 171, 173 are parallel to one another, and are generally parallel to a length of the rail 52. In some embodiments, the jaw axes 171, 173 could be oriented differently.

The jaws 102, 104 are mirror images of one another. Therefore, only the jaw 102 will be described herewith. Features of the jaw 104 similar to those of the jaw 102 have been labeled with the same reference numerals in the accompanying figures.

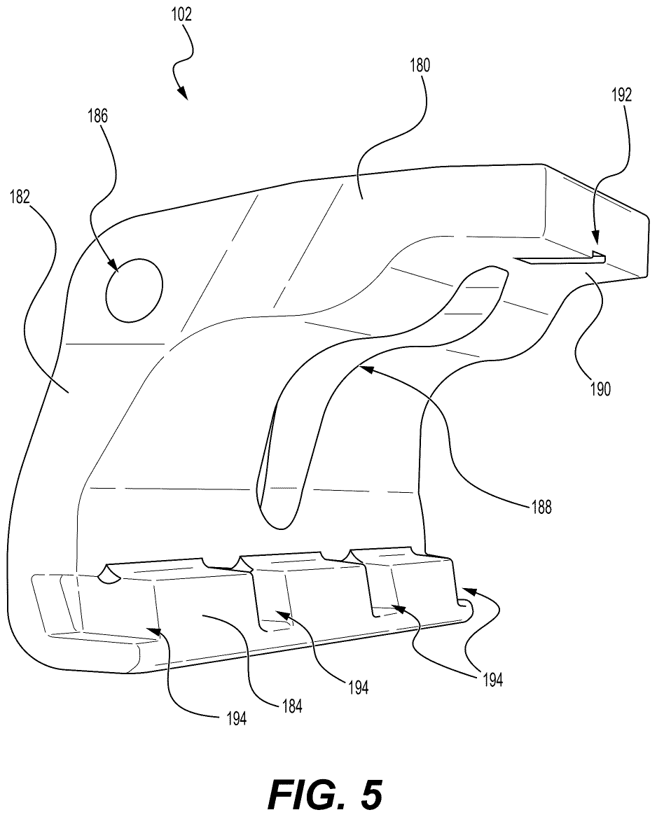

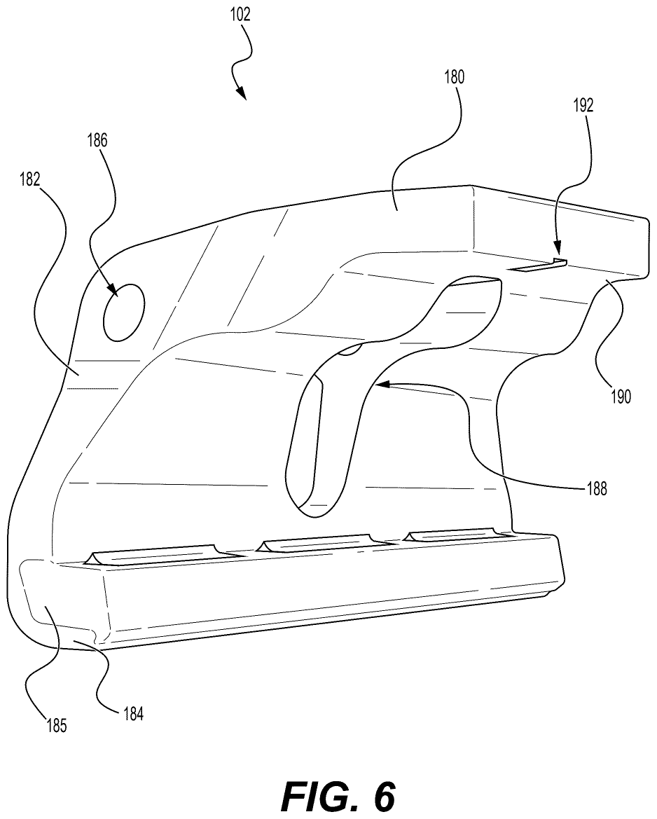

Referring to FIGS. 5 and 6, the jaw 102 has an upper portion 180, a side portion 182 extending generally downwardly from an end of the upper portion 180 and a jaw portion 184 extending generally laterally inwardly from the side portion 182.

The jaw 102 defines a shaft aperture 186 generally at an intersection of the upper and side portion 180, 182. The shaft aperture 186 extends in the longitudinal direction throughout an entirety of the jaw 102, and receives the shaft 170 therethrough.

The jaw 102 further defines an actuator aperture 188. The actuator aperture 188 extends vertically from the upper portion 180 to part of the side portion 182. The actuator aperture 188 extending along a height of the jaw 102 enables the jaw 102 to move between the open and closed positions without undesirably abutting (i.e., without undesirable interference with) the actuator 110.

The upper portion 180 has an engaging surface 190. The engaging surface 190 is disposed opposite to the side portion 182. In the present embodiment, the engaging surface 190 is a generally flat surface 190. As will be described below, the flat surface of the engaging surface 190 is configured to engage with the actuator 110. It is contemplated that in some embodiments, the engaging surface 190 may be curved or shaped differently.

The upper portion 180 further has a retainer 192. In the present embodiment, the retainer 192 is a channel 192 that is defined on the flat surface 190. As will be described below, the channel 192 is configured to engage with the actuator 110 to retain the relative position between the jaw 102 and the actuator 110. It is contemplated that in other embodiments, the channel 192 may be another type of retainer, such as, for example, a protrusion or a high friction section (e.g., section with knurling or high-friction material).

The jaw portion 184 extends laterally from the side portion 182. In some embodiments, the jaw portion 184 can be generally parallel to the portion 180. In the illustrated embodiment, as shown in FIG. 6, the jaw portion 184 has a rubber portion 185 connected thereto. As best seen in FIG. 5, the jaw portion 184 defines four recesses 194. It is contemplated that there could be more or fewer than four recesses 194. The recesses 194 are configured to receive part of the rubber portion 185 therein, thereby providing a mechanical interlock between the jaw portion 184 and the rubber portion 185. In some embodiments, the rubber portion 185 is molded over the jaw portion 184 such that the rubber portion 185 is a rubber molding. In such instances, the recesses 194 can facilitate the overmolding process. It is contemplated that the rubber portion 185 could be replaced with another resilient portion. It is also contemplated that the rubber portion 185 could be omitted in some embodiments.

Shown in FIG. 3, the biasing members 106, 108 are torsional springs, though other types of biasing members are contemplated. The biasing member 106 is operatively connected to the jaw 102 and to the housing 100. The biasing member 108 is operatively connected to the jaw 104 and to the housing 100. The biasing members 106, 108 bias the jaws 102, 104 toward their open position. It is contemplated that the biasing members 106, 108 may bias the jaws 102, 104 toward their closed position in other embodiments.

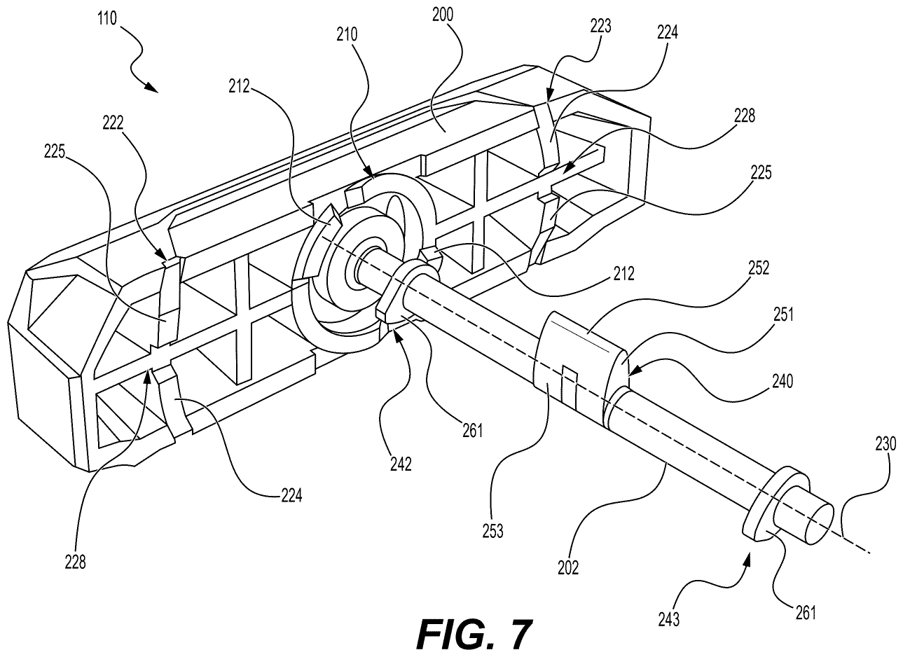

Referring to FIG. 7, the actuator 110 will now be described in greater detail. The actuator 110 includes a handle 200 and a shaft 202 operatively connected to the handle 200.

In the present embodiment, the handle 200 and the shaft 202 are connected to one another via fasteners (not shown), though it is contemplated that the handle 200 and the shaft 202 may be connected to one another differently. In some embodiments, the handle 200 and the shaft 202 may be integral with one another. The shaft 202 is connected at a longitudinal center point of the handle 200. It is contemplated that in other embodiments, the shaft 202 could be connected to a longitudinal end of the handle 200 (e.g., such that the handle 200 would act as a lever). Thus, in this embodiment, the handle 200 and the shaft 202 are fixedly connected to one another, such that when one of the handle 200 or the shaft 202 rotates, the other one also rotates.

The handle 200 has a central rib 210. The central rib 210 is generally circular, and has first actuator indicators 212. More specifically, the first actuator indicators 212 are raised sections of the central rib 210. As will be described in greater detail below, the first actuator indicators 212 are configured to engage with the first housing indicators 146.

The handle 200 also has second actuator indicators 222, 223. Each one of the second actuator indicators 222, 223 has a guiding rib 224, a stopping rib 226 and a recess 228 separating the guiding and stopping ribs 224, 226. The second actuator indicators 222, 223 differ from one another in that the guiding rib 224 is vertically below the stopping rib 225 for the second actuator indicator 222, whereas the guiding rib 224 is vertically above the stopping rib 225 for the second actuator indicator 222. As will be described below, the second actuator indicators 222 are configured to engage with the second housing indicators 147.

Still referring to FIG. 7, the shaft 202 will now be described in greater detail.

The shaft 202 defines an actuator axis 230. The shaft 202 is oriented such that the actuator axis 230 is generally perpendicular to the jaw axes 171, 173. The actuator 110 is pivotable with respect to the housing 100 about the actuator axis 230.

The shaft 202 has a central engaging portion 240 and side engaging portions 242, 243. The central engaging portion 240 is generally centered between both ends of the shaft 202. As will be described in greater detail below, the central engaging portion 240 is configured to engage with both of the jaws 102, 104. The side engaging portion 242, which is disposed at one end of the shaft 202, is configured to engage with the jaw 102. The side engaging portion 243, which is disposed at the other end of the shaft 202, is configured to engage with the jaw 104. It is contemplated that in embodiments with only one pivoting jaw, there would only be one side engaging portion 242. It is further contemplated that the side engaging portions 242, 243 could be omitted altogether.

The central engaging portion 240 is a central cam 240 with an elongated portion 251. The elongated portion 251 has a curved side 253. Additionally, at the end of the elongated portion 251, the central cam 240 has a flat surface 252. As will be described below, the flat surface 252 is configured to engage with the flat surfaces 190 of the jaws 102, 104 (i.e., the central engaging portion 240 is configured to engage withe the engaging surfaces 190). In the present embodiment, the elongated portion 251 is partially received in the channel 192 when the clamp 50 is in the clamped configuration. This engagement can assist in retaining the relative position between the jaws 102, 104 and the shaft 202.

In the illustrated embodiment, the central cam 240 is oriented such that its elongated portion 251 is generally perpendicular to a direction of the handle 200. It is contemplated however, that the elongated portion 251 could be oriented differently (e.g., parallel to handle 200).

The side engaging portions 242, 243 are side cams 242, 243. Each one of the side cams 242, 243 has an elongated portion 261. Each elongated portion 261 is angularly aligned with one another, and angularly offset from the elongated portion 251 of the central cam 240.

The actuator 110 is moveable between a non-actuated position (shown in FIGS. 8A to 8D) and an actuated position (shown in FIGS. 9A to 9D). In some embodiments, the actuated position is angularly offset from the non-actuated position by about 90 degrees. As will be described below, the clamp 50 can be moved between the clamped and unclamped configurations by actuation of the actuator 110.

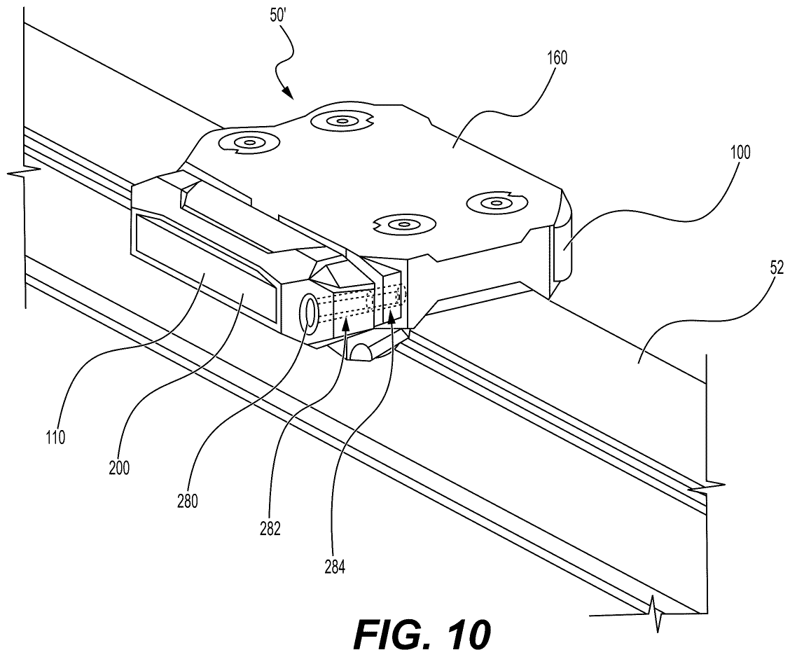

Referring to FIG. 10, an alternative embodiment of the clamp 50, namely clamp 50′ will be described. Features of the clamp 50′ similar to those of the clamp 50 have been labeled with the same reference numerals, and will not be re-described in detail herewith. The clamp 50′ notably differs from the clamp 50, in that the clamp 50′ further includes a lock 280. More specifically, the handle 202 defines a locking aperture 282 and the housing 100 defines a locking aperture 284. When the actuator 110 is in the actuated position, the locking aperture 282 is generally aligned with the locking aperture 284. The lock 280, which is a pin 280 in the present embodiment, is selectively received in the aligned locking apertures 282, 284 for preventing the handle 200, and thus the actuator 110, from moving relative to the housing 100.

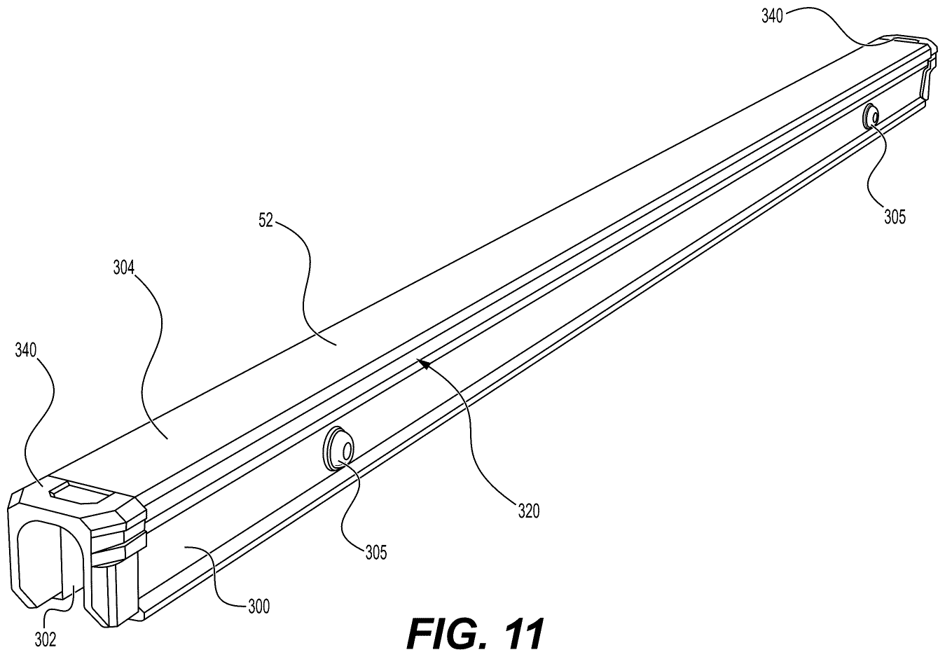

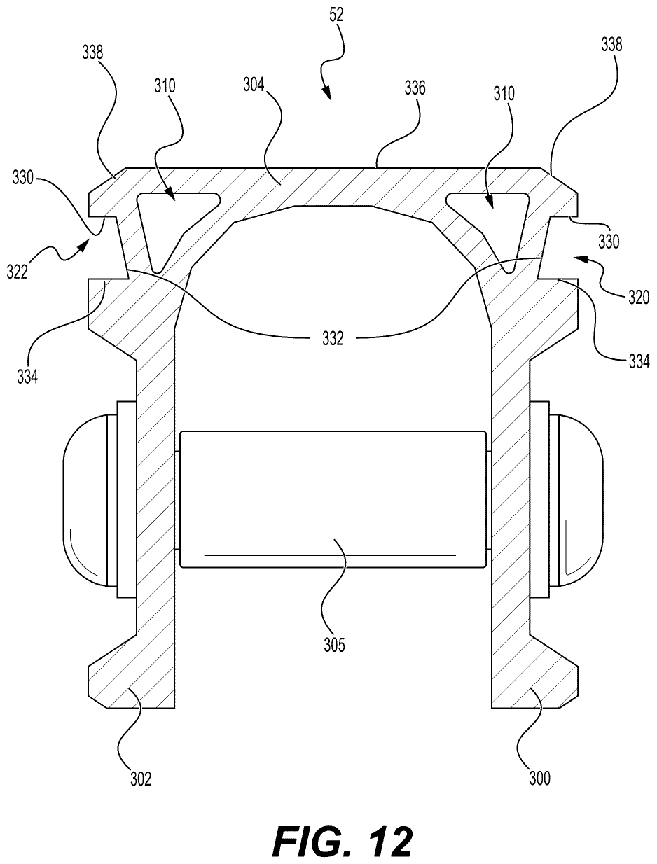

Referring to FIGS. 11 and 12, the rail 52 will now be described in greater detail. The rail 52 has side portions 300, 302 that are interconnected by an upper portion 304. The side portions 300, 302 are parallel to one another, but it is contemplated that in some embodiments, the side portions 300, 302 may be angled relative to one another. The side portions 300, 302 are connected by fasteners 305 which can enable connection of the rail 52 to another component. It is contemplated that the rail 52 may be integral (e.g. an extruded part or a casted part) in some embodiments.

Referring to FIG. 12, the upper portion 304 defines longitudinal apertures 310. The longitudinal apertures 310 assist in reducing the amount of material required to manufacture the rail 52, and may be omitted in certain embodiments.

The upper portion 304 also defines an outer side channel 320 and an outer side channel 322. Each one of the outer side channels 320, 322 is defined by an upper wall 330, a side wall 332 and a lower wall 334. In the illustrated embodiment, the side walls 332 are slanted such that the lower walls 332 are longer than the upper walls 330, though it is contemplated that configuration may vary from one embodiment to another (e.g. the side walls 332 may be generally vertical). The upper portion 304 also has a flat section 336 and angled sections 338 disposed on either lateral side of the flat section 336.

At each longitudinal end thereof, the rail 52 has an end cap 340. The end cap 340 is shaped to close off longitudinal ends of the outer side channels 320, 322.

Referring to FIGS. 8A to 8D, the clamp 50 is shown in the unclamped configuration. When the clamp 50 is in the unclamped configuration, the actuator 100 is in the non-actuated position and the jaws 102, 104 are in their open positions. Thus, the jaws 102, 104 do not project from the apertures 155 defined in the side members 150, 152. It can be said that the jaws 102, 104 are retracted, at least partially, into the housing 100. The jaws 102, 104 are biased toward the open position in this embodiment. Additionally, the side cams 242, 243 engage the jaws 102, 104 respectively, thereby preventing the jaws 102, 104 to move toward their close positions in this embodiment.

This configuration enables the clamp 50 to be disposed on the rail 52 such that a bottom surface of the housing 100 abuts the top portion 304 of the rail 52. More specifically, the angled surfaces 148 of the housing 100 abut against the angled sections 338 of the rail 52, and the side members 150, 152 extend on either side of the top portion 304 (i.e., the side members 150, 152 are disposed laterally outwardly from the side portions 300, 302). Thus, when the clamp 50 is disposed on the rail 52 and is in the unclamped configuration, the clamp 50 can be moved along the length of the rail 52 (for example via sliding) or vertically away from the rail 52, but not laterally relative to the rail 52 due to the engagement between the side members 150, 152 and the rail 52.

It will be appreciated that the clamp 50 is configured such that a user may place the clamp 50 generally anywhere along a length of the rail 52. Thus, it is not necessary to slide the clamp 50 from a longitudinal end of the rail 52. Additionally, a position of the clamp 50 relative to its connecting interface, which is the rail 52, is not limited by the position of one aperture at a specific location. Also, once the clamp 50 is placed on the rail 52, the clamp 50 can easily be moved along the length of the rail 52 due to, in part, the complementary nature of the housing 100 and the rail 52. In some instances, movement of the clamp 50 can be limited by the engagement of the side members 150, 152 with the end caps 340.

To move the clamp 50 to the clamped configuration, the actuator 110 is moved to the actuated position. This can be done by grasping the handle 202 and rotating it about the actuator axis 230. Rotation of the handle 202 causes rotation of the shaft 202. As the shaft 202 rotates, the curved side 253 of the central cam 240 engages the jaws 102, 104 and causes the jaws 102, 104 to move toward the closed position. It will be appreciated that the rotational movement of the shaft 202 is in part guided by its engagement with the arcuate edge 129 of the guiding rib 128.

The actuator 110 is rotated until the actuated position is reached. The user may know that the actuator 110 has reached the actuated position due to the engagement between the first and second housing indicators 146, 147 and the first and second actuator indicators 212, 222, 223. More specifically, when the actuator 110 reaches the actuated position, the first actuator indicators 212 abut the first housing actuators 146. Additionally, the second actuator indicators 222, 223 abut the second housing actuators 147. More specifically, the second housing indicators 147 are received in respective recesses 228, and abut against respective stopping ribs 226. The engagement between the second actuator indicators 222, 223, and the second housing actuators 147 can, in addition to indicating that the actuated position has been reached, assist in maintaining relative position between the actuator 110 and the housing 100.

When the actuator 110 reaches the actuated position, the jaws 102, 104 are in their closed positions such that the jaws 102, 104 project from their respective apertures 155. It can be said that the jaws 102, 104 extend out of the housing 100. The jaws 102, 104 partially surround rail 52.

While the jaws 102, 104 are biased toward their open positions in this embodiment, the central cam 240 pushes (i.e., applies a force) onto the jaws 102, 104. More specifically, the flat surface 252 pushes on the flat surfaces 190 of the jaws 102, 104. This assists in preventing relative movement between the central cam 240 and the jaws 102, 104. Additionally, part of the elongated portion 251 is received in the channel 192, thereby further preventing relative movement therebetween.

When the jaws 102, 104 are in their closed positions, the jaw portion 184 of the jaw 102 is received in outer side channel 320, and the jaw portion 184 of the jaw 104 is received in the outer side channel 322. The force applied by the central cam 240 causes the jaws 102, 104 to also apply a force on to the rail 52. Thus, the rubber portions 185 are resiliently deformed between the housing 100 and the jaws 100, 102. This can assist in reducing transmission of vibrations between the housing 100 and the rail 52. This can also assist in reducing likelihood of scratching between mated surfaces. Additionally, a clamping force applied by the clamp 50 on the rial 52 is enhanced.

When the clamp 50 is in the clamped configuration, the clamp 50 and the rail 52 are generally fixed relative to one another, such that movement of clamp 50 along the length of the rail 52 and vertically away from the rail 52 are also restricted.

It will be appreciated that while the present technology discloses features for limiting and/or preventing movement of parts relative to another, a person skilled in the art will understand that some of these can be selectively overcome (e.g., by rotating the handle 200 with sufficient force).

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. A clamp for coupling an accessory to a rail, the clamp comprising:
a housing;
a first jaw disposed on a first side of the housing, a second jaw disposed on a second side of the housing, the second side being opposite to the first side, and at least one of the first jaw and the second jaw is a pivoting jaw pivotable relative to the housing about a jaw axis between an open position and a closed position;
a biasing member biasing the pivoting jaw toward the open position;
an actuator connected to the housing, the actuator being pivotable relative to the housing about an actuator axis between an actuated position and a non-actuated position;
in response to the actuator moving from the non-actuated position toward the actuated position, the actuator causing the pivoting jaw to move toward the closed position, and
the clamp having:
an unclamped configuration; and
a clamped configuration in which the actuator is in the actuated position, the pivoting jaw is in the closed position, and the actuator prevents the pivoting jaw to move toward the open position.

2. The clamp of claim 1, wherein in the unclamped configuration, the actuator is in the non-actuated position, and the pivoting jaw is in the open position.

3. The clamp of claim 2, wherein in the unclamped configuration, the actuator prevents the pivoting jaw to move toward the closed position.

4. The clamp of claim 1, wherein the actuator includes a handle and a shaft rotationally fixed to the handle.

5. The clamp of claim 1, wherein the non-actuated position and the actuated position are angularly spaced from one another by about 90 degrees.

6. The clamp claim 1, wherein the actuator axis extends from the first side of the housing to the second side of the housing, and is generally perpendicular to the jaw axis.

7. The clamp of claim 1, wherein the housing has a housing indicator, the actuator has an actuator indicator, and in response to the actuator being in one of the actuated position and the non-actuated position, the actuator indicator engages with the housing indicator.

8. The clamp of claim 1, wherein:
the actuator has an engaging portion; and
the pivoting jaw has an engaging surface, and
with the clamp being in the clamped configuration, the engaging portion engages the engaging surface.

9. The clamp of claim 8, wherein the engaging portion is a cam.

10. The clamp of claim 9, wherein the cam has a flat surface configured to engage the engaging surface.

11. The clamp of claim 1, wherein at least one of the actuator and the pivoting jaw has a retainer configured to retain the clamp in the clamped configuration.

12. The clamp of claim 11, wherein the retainer is a channel, the channel being defined in the pivoting jaw, and being configured to receive part of the actuator therein.

13. The clamp of claim 1, further comprising a lock for locking the actuator in the actuated position, wherein:
the actuator defines a first locking aperture;
the housing defines a second locking aperture; and
the lock is a pin selectively received in the first locking aperture and the second locking aperture for locking a position of the actuator with respect to the housing.

14. The clamp of claim 1, further comprising a top plate connected to the housing, the top plate being configured to connect to an accessory.

15. The clamp of claim 1, wherein the housing is at least partially complementary to the rail.

16. The clamp of claim 1, wherein at least one of the first jaw and the second jaw has a rubber portion.

17. The clamp of claim 1, wherein:
the pivoting jaw is a first pivoting jaw;
an other one of the at least one of the first jaw and the second jaw is a second pivoting jaw; and
the biasing member biases the first jaw toward the open position.

18. The clamp of claim 17, wherein the biasing member is a first biasing member, and the clamp further includes a second biasing member biasing the second pivoting jaw toward the open position.

19. A connection assembly comprising:
a rail; and
the clamp of claim 1 selectively connected to the rail.

20. The connection assembly of claim 19, wherein the clamp is configured to be selectively connected to the rail in a plurality of positions along a length of the rail.
